(19) United States
(12) Patent Application Publication
(10) Pub. No.: US 2018/0068531 A1
(43) Pub. Date: Mar. 8, 2018

(54) METHOD AND SYSTEM FOR OPERATING A GAMING MACHINE

(71) Applicant: Craig Nouis, Pearland, TX (US)

(72) Inventor: Craig Nouis, Pearland, TX (US)

(21) Appl. No.: 15/696,835

(22) Filed: Sep. 6, 2017

Related U.S. Application Data
(60) Provisional application No. 62/383,687, filed on Sep. 6, 2016.
(60) Provisional application No. 62/403,289, filed on Oct. 3, 2016.

(51) Int. Cl. G07F 17/32

(52) U.S. Cl. CPC G07F 17/3288; G07F 17/3241; G07F 17/3244

(57) ABSTRACT

Disclosed is a method of operating a gaming machine. The method includes receiving, using a processing device, a gaming request from a user. The gaming request comprises indication of at least one of a count of the multiple plays and a time period of the gaming session, at least one wagering amount associated with the gaming session and at least one time-schedule associated with the gaming session. Further, the method includes receiving, using a processing device, an assignment request comprising indication of at least one assignee. Yet further, the method includes executing, using the processing device, the gaming session. Further, the method includes determining, using the processing device, at least one winning result associated with the gaming session. Moreover, the method includes assigning, using the processing device, at least a portion of the winning amount to the at least one assignee.

The current application claims a priority to the U.S. Provisional Patent application Ser. No. 62/383,687 filed on Sep. 6, 2016. The current application also claims a priority to the U.S. Provisional Patent application Ser. No. 62/403,289 filed on Oct. 3, 2016.

### FIELD OF THE INVENTION

The present invention relates to electronic casino games. In particular, the present invention relates to a method and a system for operating a gaming machine.

### BACKGROUND OF THE INVENTION

Players enjoy gambling on electronic casino games, such as slot machines, video lottery terminals, other gaming devices and other electronic casino games. The players enjoy gambling for the excitement, for the entertainment, for social purposes and to win money. The casino operators are always seeking new, exciting and entertaining methods for its patrons to gamble. Further, the players are always seeking new, exciting and entertaining methods to gamble including participating or Playing Electronic Casino Games. However, it is becoming a challenge to provide new experiences to the players.

Further, while at a casino, the players may want to play a gaming device, however, the players may be distracted with other activities and they may be unable to sit down and play an electronic gaming device. Moreover, the players may want to share their winning with their relatives, friends, and co-workers.

Accordingly, there is a need for methods and systems for operating gaming machines that provide the players with new, exciting and entertaining ways to gamble.

### SUMMARY OF THE INVENTION

This summary is provided to introduce a selection of concepts in a simplified form that are further described below in the Detailed Description. This summary is not intended to identify key features or essential features of the claimed subject matter. Nor is this summary intended to be used to limit the claimed subject matter's scope.

Disclosed is a method of operating a gaming machine. The method includes receiving, using a processing device, a gaming request from a user, wherein the gaming request is associated with a gaming session comprising multiple plays. The gaming request comprises indication of at least one of a count of the multiple plays and a time period of the gaming session, at least one wagering amount associated with the gaming session and at least one time-schedule associated with the gaming session, wherein one or more plays of the plurality of plays are initiated according to the at least one time-schedule. Further, the method includes receiving, using a processing device, an assignment request comprising indication of at least one assignee. Yet further, the method includes executing, using the processing device, the gaming session. Further, the method includes determining, using the processing device, at least one winning result associated with the gaming session. Moreover, the method includes assigning, using the processing device, at least a portion of the winning amount to the at least one assignee.

According to further aspects, a system of operating a gaming machine is disclosed. The system comprising a processing device configured for receiving a gaming request from a user, wherein the gaming request is associated with a gaming session comprising a plurality of plays. The gaming request comprises indication of at least one of a count of the plurality of plays and a time period of the gaming session, at least one wagering amount associated with the gaming session, and at least one time-schedule associated with the gaming session. The one or more plays of the plurality of plays are initiated according to the at least one time-schedule. The processing device is further configured for receiving an assignment request comprising indication of at least one assignee and executing the gaming session. Further, the processing device configured for determining at least one winning result associated with the gaming session. Moreover, the processing device configured for assigning at least a portion of the winning amount to the at least one assignee.

The players enjoy betting on sports games or events, such as football, baseball, basketball, NASCAR, horse racing or dog racing. The players place bets on a game in advance of the game or event, then watch the game at the scheduled time or at a later date and time to see if they won or lost the bet. Similarly, the players of the disclosed systems would enjoy participating in an electronic casino game through scheduling a game session and watching the play of the game at the scheduled time or at a later date and time to see if the player won or lost from the play of the scheduled game session. This allows the player the opportunity to watch at the scheduled time, watch a replay at a later time to further analyze the play of the game and allow others to watch the play of the game session.

Further, if a player is distracted with other activities at the casino and is unable to sit down and play an electronic gaming device, then the player may schedule a gaming session. Therefore, the player may participate in a game session and play other casino games, eat at the restaurants, visit with friends, go the room, go the pool, go to the bar or lounge, go to a show or any other activities that players enjoy doing while at a casino or any other activities. Scheduling a gaming session allows the players to do multiple activities at the same time. The players may watch the play of the game session at the scheduled date and time or at a later time and date. For example, a player may be playing poker and at the same time playing, watching or monitoring the scheduled game session. This results in providing the player additional flexibility with their schedule while in a casino and provides the player additional excitement while participating and watching an electronic casino game while playing other games or enjoying other activities.

Yet further, additional excitement for the players is provided through assigning all or a portion of a game session to other individual such as relatives, friends, co-workers, etc. If a player is feeling lucky and wanting to share some of that excitement, he or she may participate in a game session and assign all or a portion of the game play or winnings to an assignee. When scheduling a game session, a player may identify an assignee through a unique identifier link that may be assigned all or a portion of the winnings from the game session, if any. The players may also want to assign any winnings for a birthday gift, other types of entertainment gifts, and share the excitement. The assignee is not betting or risking any amount of his or her own money to play. This is similar to lottery tickets that individuals will frequently purchase then gives the tickets to other individuals for various reasons, for example a birthday gift. The individual that receives the ticket scratches off the ticket for entertainment purposes and if the ticket results in a win, then they keep the winnings from the lottery ticket. For the assignee, this is for entertainment.

According to some aspects, the present disclosures provides a casino the ability to offer its patrons new, exciting and entertaining methods to play electronic casino games. The disclosed system and method provides a player alternative ways to participate in the play of an electronic casino game. The player has the ability to participate in a game session that is played on an electronic casino game that requires the player to purchase in advance, a fixed number of plays or spins on an electronic casino game, at a fixed wager and schedule the play of a game session for immediate play or at a future date and time. The disclosed system and method further provides: (1) an option for the player to make side bets on the final results or elements of certain game sessions (2) the player the ability to assign all or a portion of any winnings from a game session to an assignee (3) the player the ability to “repeat” certain game sessions immediately or at a future date and time (4) player may provide a identifier link, such as email or text number that enables a player or other designated individual or individuals the ability to watch or monitor the game session for entertainment purposes at the scheduled time and at a future date and time. Once a game session is purchased and scheduled, the player is not required to physically be at a player station or any gaming device to participate or play in the game session.

As an alternative, the disclosed system and method also provides a player the ability to participate in a scheduled game session through scheduling the starting date and time and the ending date and time of the electronic casino game.

As a result of certain gaming session having a defined number of spins or plays it allows players to participate in new types of games that are not able to be played on traditional slot machines or similar devices. Examples of games are provided below.

A game session may be structured whereby a player may initiate and participate in a game session challenge game where the player competes directly against one or more “house” game sessions. the challenge may be the result of the end results of the game session or any elements derived from the play of a game session. if the player ends up with the best points level at the end of the game session wins the challenge.

Another game session may be structured whereby a player may initiate and participate in a game session challenge game where the player competes directly against another player or multiple players game sessions. the challenge may be the result of the end results of the game session or any elements derived from the play of a game session. the participant with the best point level at the end of the game session wins the challenge.

Another method for a player to participate in a game session is a slot odds game session, whereby a player places a wager based on the odds of achieving certain elements during the play of the game session and on the actual results of a game session. If the players correctly wagers on one or more winning elements and results of the game session, the player will win the corresponding payouts. the payouts to the player for achieving the elements and results is based on the odds of achieving the elements and results for that game session.

Another method for a player to participate in a game session is an over/under game session, whereby a player places wager if the ending credits from the play of the game session will be over or under a certain credit amount that is determined in advance. if the result of the game session results in the player winning the bet, then the player wins the predetermined payout.

Another method for a player to participate in a game session in a multi-player game session. a multi-player game session is a system or method that a casino has a game session that continuously plays for a period of time. during this continuous play time period, a player or multiple players may independently participate in the same multi-player game session. this allows multiple players to participate in the same electronic casino game.

The player may play, participate, watch or monitor the game session at the scheduled time, or at a later date and time, on a player station, on a slot machine, on a PDA device, the internet, on any other method to participate, watch or monitor the play of a casino game.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 illustrates an exemplary environment in which embodiments of the present disclosure may be implemented.

FIG. 2 is a block diagram of a system for operating a gaming machine, in accordance with some embodiments.

FIG. 3 is a schematic diagram showing a casino with a gaming machine and a player's home, in accordance with some embodiments.

FIG. 4 is a schematic diagram of a user interface of a gaming machine, in accordance with some embodiments.

FIG. 5 illustrates a flowchart of a method of operating a gaming machine, in accordance with some embodiments.

FIG. 6 illustrates a flowchart of a method for assigning winnings, in accordance with some embodiments.

FIG. 7 illustrates a flowchart of a method for tracking a gaming machine, in accordance with some embodiments.

FIG. 8 illustrates an exemplary computing system that may be employed to implement processing functionality for various embodiments.

### DETAILED DESCRIPTION OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

The present disclosure includes many aspects and features. Moreover, while many aspects and features relate to, and are described in, the context of gaming machines, embodiments of the present disclosure are not limited to use only in this context.

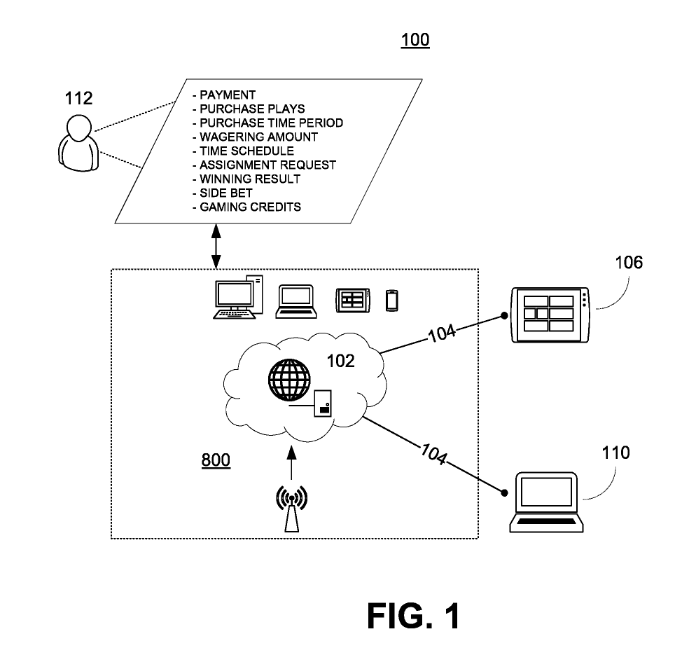

Referring now to figures, FIG. 1 is an illustration of a platform consistent with various embodiments of the present disclosure. By way of non-limiting example, the online platform 100 for operating a gaming machine may be hosted on a centralized server 102, such as, for example, a cloud computing service. The centralized server 102 may communicate with other network entities, such as, for example, a mobile device 106 (such as a smartphone, a laptop, a tablet computer etc.) and other electronic devices 110 (such as a gaming machine, a desktop computer, etc.) over a communication network 104, such as, but not limited to, the Internet. Further, users of the platform may include one or more relevant parties such as, game players and administrators. Accordingly, electronic devices operated by the one or more relevant parties may be in communication with the platform. For example, the platform 100 may be in communication with a device 106 operated by a game player.

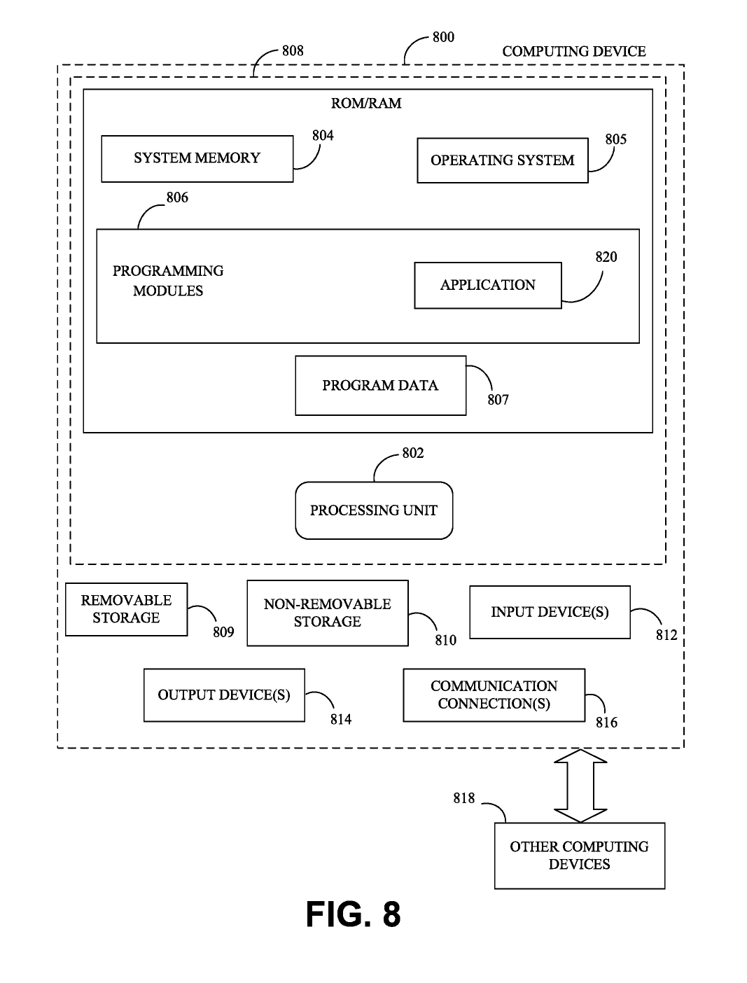

A user 112, such as the one or more relevant parties, may access platform 100 through a software application. The software application may be embodied as, for example, but not be limited to, a website, a web application, a desktop application, a mobile application and a gaming machine application compatible with a computing device 800. The computing device 800 is explained in further detail in conjunction with FIG. 8 below.

Further, the online platform 100 may allow a player (such as the user 112) to schedule a gaming session at a casino. Thereafter, the players may watch the play of the game session at the scheduled date and time or at a later time and date. This results in providing the player additional flexibility with their schedule while in a casino.

Yet further, the online platform 100 may allow a player to assign all or a portion of a game session to other individual such as relatives, friends, and co-workers. If a player is feeling lucky and wanting to share some of that excitement, he or she may participate in a game session and assign all or a portion of the game play or winnings to an assignee.

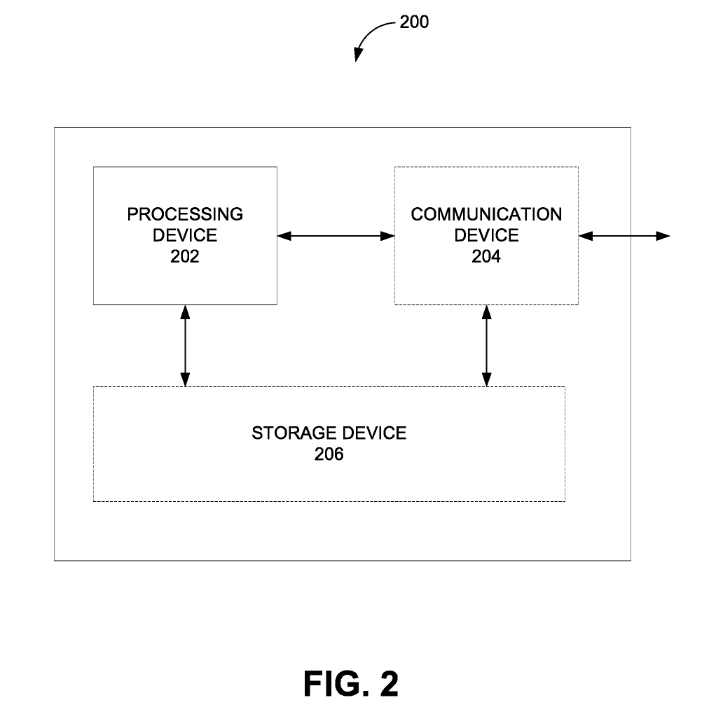

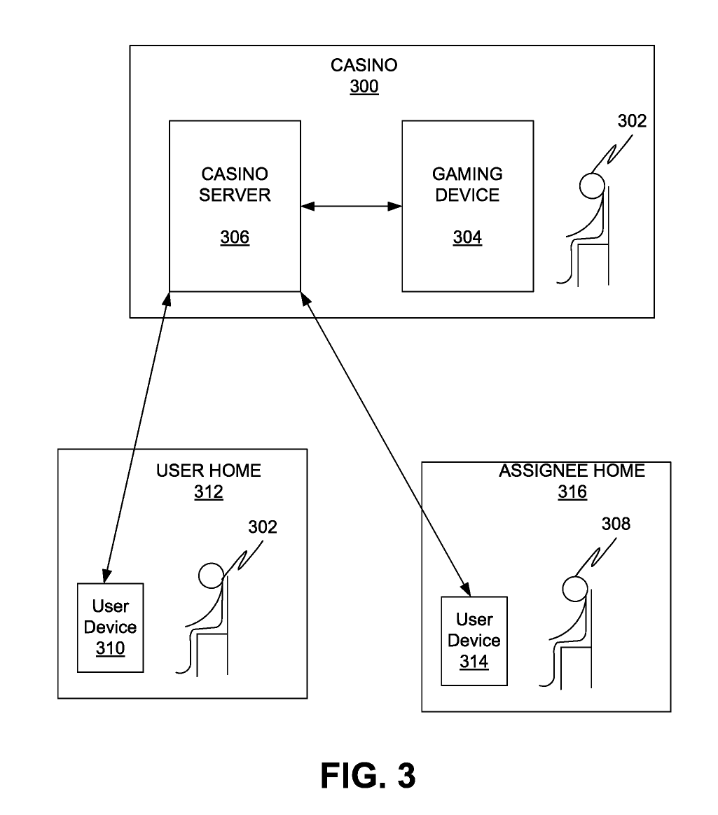

FIG. 2 is a block diagram of a system 200 for operating a gaming machine, in accordance with some embodiments. The system 200 includes a processing device 202, a communication device 204 and a storage device 206. The processing device 202 may be configured for receiving a gaming request from a user 302 shown in FIG. 3. For example, the user 302 may visit a casino 300 to submit the gaming request on a gaming machine 304. The one or more of the processing device 202, the communication device 204 and the storage device 206 may be included at least one of the gaming machine 304 and a casino server 306.

The gaming request may be associated with a gaming session including multiple plays. Further, the gaming request may include indication of one or more of a count of the multiple plays and a time period of the gaming session. In some embodiments, the processing device 202 may be further configured for deducting gaming credits from an account of the user 302 associated with the gaming request. The gaming credits may be based on one or more of the count and the time period.

Further, the gaming request may include an indication of at least one wagering amount associated with the gaming session. Yet further, the gaming request may include indication of at least one time-schedule associated with the gaming session. Further, one or more plays of the multiple plays may be initiated according to the at least one time-schedule. Further, the at least one time-schedule may include a play interval, wherein a time gap between initiation of two consecutive plays is based on the play interval.

In further embodiments, the gaming request further may include an indication of automatically repeating the gaming session, at least one condition based on which the gaming session may be automatically repeated and a time of repeating the gaming session.

The information shared along with the gaming request, such as one or more of a count of the multiple plays and a time period of the gaming session, the at least one wagering amount and the at least one time-schedule, may be stored in the storage device 206.

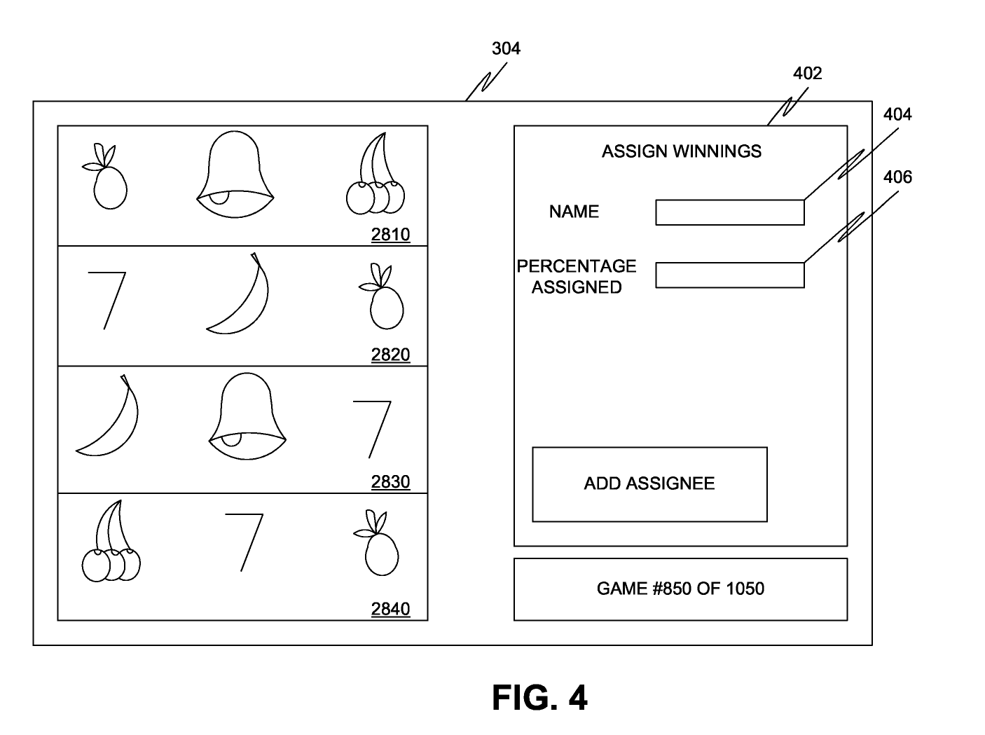

Further, the processing device 202 may be configured for receiving an assignment request including indication of at least one assignee 308. The assignment request may further include indication of at least one percentage associated with the at least one assignee 308, wherein assigning of the winning amount to the at least one assignee 308 is further based on the at least one percentage. In an exemplary embodiment, the user 302 may provide the assignment request using a “Assign Winnings” user interface 402 shown in the gaming machine 304, as shown in FIG. 4. The “Assign Winnings” user interface 402 includes a “Name” field 404 for receiving the name of the at least one assignee 308. Further, the “Assign Winnings” user interface 402 includes a “Percentage assigned” field 4064 for receiving the at least one percentage.

Further, the processing device 202 may be configured for executing the gaming session. The gaming session may be executed based on the at least one time-schedule. The processing device 202 may be further configured for determining at least one winning result associated with the gaming session. The user 302 may view the gaming session using a user device 310 from a user home 312. The user device 310 may establish a connection with the casino server (or the communication device 204) to obtain information about the gaming session.

Thereafter, the processing device 202 may be configured for assigning at least a portion of the winning amount to the at least one assignee 308. In some embodiments, the processing device 202 may be configured for performing one or more of crediting at least one assignee account associated with the at least one assignee 308 with the portion of the winning amount and transmitting, using the communication device 204, a message to at least one user device 314 associated with the at least one assignee 308. The at least one assignee 308 may receive the message at their home 316. For example, the message may be a congratulatory message to the at least one assignee 308 informing them of the winning. Further, the message may be sent via one or more of an email, an SMS and a call.

In further embodiments, the processing device 202 may be further configured for receiving at least one side bet associated with the gaming session. Further, the at least one side bet may include each of a predicted result of the gaming session and a side bet amount. The predicted result may include a quantity of gaming credits remaining upon completion of the gaming session. In some embodiments, the predicted result may include a numerical characteristic of gaming credits remaining upon completion of the gaming session. For example, the numerical characteristic of gaming credits may include the ending credits being odd or even and above or below a certain limit.

In further embodiments, the processing device 202 may be further configured for receiving, using an input device, identifying data associated with one or more of the user 302 and the at least one assignee 308. For example, the input device may be the gaming machine 304, wherein the user 302 may provide the identifying data associated with one or more of the user 302 and the at least one assignee 308 via the “Assign Winnings” user interface 402. Further, the processing device 202 may be configured for identifying one or more of the user 302 and the at least one assignee 308 based on the identifying data. The processing device 202 may be further configured for dispensing at least one item based on the identifying. For example, the at least one item may include one or more of a casino token, a currency note, a coin and a product. Further, one or more of a type and a quantity of the at least one item may be based on the winning amount.

In further embodiments, the processing device 202 may be further configured for monitoring a state of the gaming machine 304 associated with the gaming session. Further, the processing device 202 may be further configured for transmitting, using the communication device 204, the state of the gaming machine 304 to one or both of the user device 310 and the user device 314.

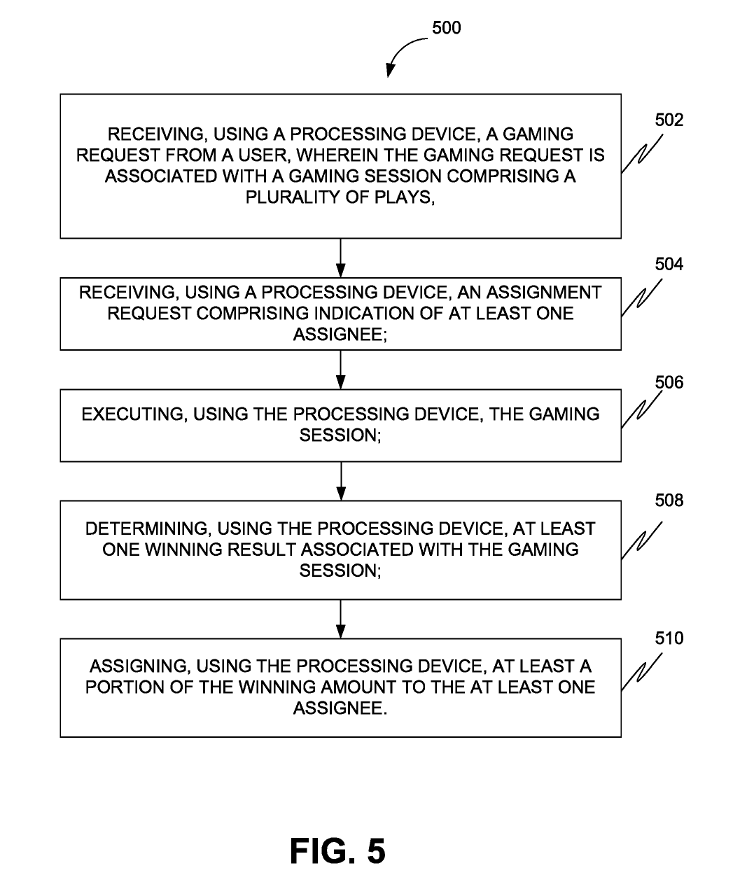

FIG. 5 illustrates a flowchart of a method 500 for operating the gaming machine 304, in accordance with some embodiments. At 502, the method 500 includes receiving, using the processing device 202, a gaming request from the user 302. Further, the gaming request may be associated with a gaming session including multiple plays. Further, the gaming request may include indication of one or more of a count of the multiple plays and a time period of the gaming session. Further, the gaming request may include indication of at least one wagering amount associated with the gaming session. Further, the gaming request may include indication of at least one time-schedule associated with the gaming session. Further, one or more plays of the multiple plays may be initiated according to the at least one time-schedule.

In some embodiments, the at least one time-schedule may include a play interval. Further, a time gap between initiation of two consecutive plays may be based on the play interval.

In some embodiments, the gaming request further may include an indication of automatically repeating the gaming session, at least one condition based on which the gaming session may be automatically repeated and a time of repeating the gaming session.

Thereafter, at 504, the method 500 includes receiving, using the processing device 202, an assignment request including an indication of the at least one assignee 308. In some embodiments, the assignment request further may include an indication of at least one percentage associated with the at least one assignee. Further, assigning of the winning amount to the at least one assignee may be further based on the at least one percentage.

Next, at 506, the method 500 includes executing, using the processing device 202, the gaming session. At 508, the method 500 includes determining, using the processing device 202, at least one winning result associated with the gaming session. Then, at 510, the method 500 includes assigning, using the processing device 202, at least a portion of the winning amount to the at least one assignee.

In further embodiments, the method 500 may further include deducting, using the processing device 202, gaming credits from an account of the user associated with the request. Further, the gaming credits may be based on one or more of the count and the time period.

In some embodiments, the method 500 may further include receiving, using the processing device, at least one side bet associated with the gaming session. Further, the at least one side bet may include each of a predicted result of the gaming session and a side bet amount. The predicted result may include a quantity of gaming credits remaining upon completion of the gaming session. In some embodiments, the predicted result may include a numerical characteristic of gaming credits remaining upon completion of the gaming session.

In some embodiments, the method 500 may further include performing one or more of: crediting, using the processing device 202, at least one assignee account associated with the at least one assignee 308 with the portion of the winning amount and transmitting, using the communication device 204, a message to at least one user device 314 associated with the at least one assignee 308.

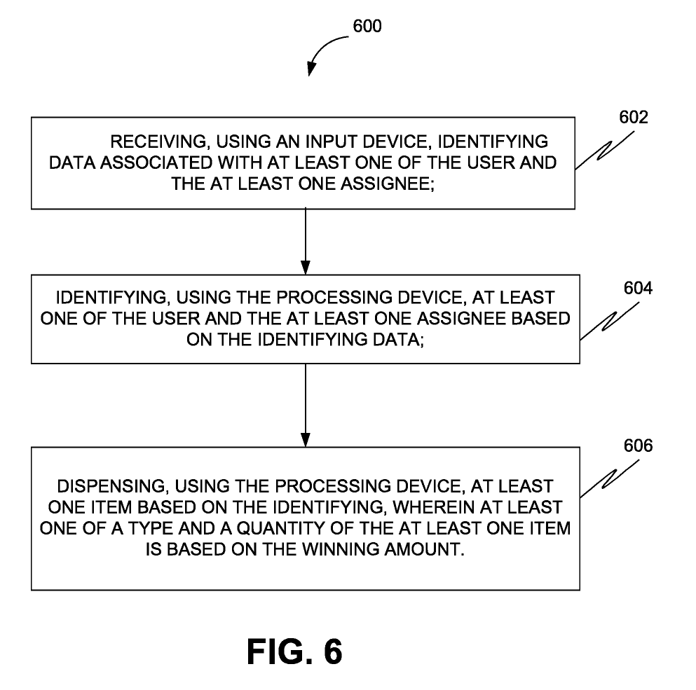

FIG. 6 illustrates a flowchart of a method 600 for assigning winnings, in accordance with some embodiments. At 602, the method 600 includes receiving, using an input device (such as the gaming machine 304), identifying data associated with one or more of the user 302 and the at least one assignee 308. Then, at 604, the method 600 includes identifying, using the processing device 202, one or more of the user 302 and the at least one assignee 308 based on the identifying data. Then, at 606, the method 600 includes dispensing, using the processing device 202, at least one item based on the identifying. Further, one or more of a type and a quantity of the at least one item may be based on the winning amount.

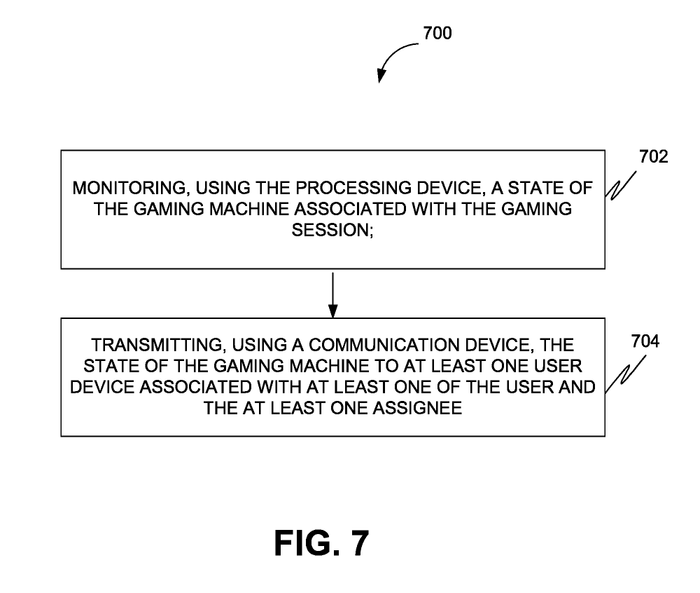

FIG. 7 illustrates a flowchart of a method 700 for tracking the gaming machine 304, in accordance with some embodiments. At 702, the method 700 includes monitoring, using the processing device 202, a state of the gaming machine 304 associated with the gaming session.

Then, at 704, the method 700 includes transmitting, using the communication device 204, the state of the gaming machine to at least one user device associated with one or more of the user (the user device 310) and the at least one assignee (the user device 314).

According to some aspects, the present disclosure allows a player to purchase a game session on an electronic casino game. The game session may have a predetermined number of spins or plays for a fixed wager or has a predetermined time period.

In further aspects, a player may purchase a game session for “defined number of spins or plays” in advance of the game session at a fixed cost. For example, the player may purchase a game session to include 25 plays or spins, 50 plays or spins, 100 plays or spins, 200 plays or spins or any other predetermined number of plays or spins. The number of spins or plays must be determined and the schedule must be determined when purchasing the game session and participating in a game session. For example, a player may participate in a $20 game session that starts at 8:30 PM on August 23, 20XX and the game session ends after 200 spins or plays. Alternatively, a player may participate in a $30 game session that starts immediately and the game session ends after 300 spins or Plays. The player may not have the ability to stop a game session in the middle of the game session. Once the player purchases the game session the wager cannot be changed by the player.

In further aspects, a player may a game session for a “defined period of time”. For example, the player may purchase a game session that may last for 15 minutes, 30 minutes, 60 minutes or any other predetermined time periods. The time period is scheduled in advance when purchasing the game session. For example, a player may participate in a 30-minute game session that starts at 8:30 PM on Aug. 23, 20XX and the game session ends at 9:00 PM on Aug. 23, 20XX. Alternatively, a player may participate in a game session that starts immediately and the game session ends in 30 minutes. The player purchases a time period game session via either of two methods, (1) on a fixed dollar amount for the game session or (2) on a per spin or play basis as long as there are sufficient funds in the players Account. Once the player purchases the game session the wager may not be changed by the player.

According to some aspects, the present disclosure also provides the player with an option to place a side bet on the results of the game session. For example, the player may place a $1 wager that at the end of the game session that the player will predict the ending credits of 335 for the game session. It is predetermined that if the player correctly predicts the ending credits, then the player wins 100 times the side bet or in this case $100. If the player ends up with 335 credits from the game session, then the player would win the 335 credits plus the $100 for correctly predicting the ending credit amount. This adds an additional level of excitement for the player to participate in an electronic casino game. Alternatively, the casino operator may offer any other types of side bets based on various elements or results of a game session.

Another example of a side bet that a player may participate is odd/even side bet. The player has the ability to place a wager on a fixed spin or play game session if the ending credit amount from the game session would be an even number or an odd number. If the player correctly bets and chooses the correct result, odd or even, then the player wins the payout for that Side Bet.

According to some aspects, the present disclosure also provides, for certain game sessions that a player, with the ability to determine the length of time to initiate each of the play or spins during the game session. For example, the player may initiate the spin or play of the game to occur immediately or the player may select to have 5 seconds, 10 seconds, 15 seconds or any other time intervals between the spins or Plays. Depending upon the game session, this provides the player an option of playing a certain game session at a fast pace or at a slow pace.

According to further aspects, a player may have the ability to schedule the repeat of one or more additional game sessions if certain conditions exist after the play of a game session. The player determines in advance the conditions that will repeat a game session. For example, the player may designate to repeat the game session immediately or at a later date and time (1) if the players game account exceeds a certain dollar amount, for example in excess of $50.00, and (2) if the players game account is below a certain dollar amount, for example below $500. The player may repeat a game session for immediate replay of the game session or a scheduled replay of the game session at a specific date and time. For example, (1) every 2nd day at 8:00 PM starting on October XX, 20XX, or (2) every Friday night at 8:00 PM, or (3) every 60 minutes starting at 8:00 PM

According to some aspects, the present disclosure also provides the player the ability to “Assign” all or a percentage of the player's winnings resulting from a game session to an assignee when the player is purchasing the game session. The player placing the wager has the risk of the bet and is only assigning all or portion of the winnings if the game session results in a win. The assignee is not purchasing or risking any money in the game session. This is similar to when someone purchases a lottery ticket and gives the lottery ticket to another person as a gift. That person receiving the gift, the assignee, enjoys the entertainment of scratching off the ticket to verify if they have a winning ticket and if the ticket results in a win, the assignee may cash in the lottery ticket to collect the winnings. For example, a player may wager $35 on a game session. The player assigns 100% of any winnings from the game session to an Assignee. The player designates a game session that begins at 8:00 PM on 3/21/20XX for 100 spins or Plays. After the end of the 100 play or spin game session, the balance in the account is $75.00. The assignee is entitled to the $75.00 winnings. Alternatively, a player may wager $35 on a game session. The player assigns 50% of any winnings from the game session to an Assignee. The player designates a game session that begins at 8:00 PM on 3/21/20XX for 100 spins or plays. After the end of the 100 play or spin game session, the balance in the account is $75.00. The assignee is entitled to 50% of the winnings of $37.50.

Further, the player may watch or monitor the game session directly on a slot machine or similar device, a PDA device, over the internet, or any type of devices available from the Casino.

According to some aspects, the present disclosure also provides a player with the ability to designate a “Game play Link” for the player, an Assignee, a friend or another person to watch or share the game session or any other electronic game play by providing a unique identifier link (for example email link, text link or any other type of link). The game session or any other electronic game play may be watched for entertainment at the scheduled time or at a later date and time. This “Game play Link” provides the player or designee a direct link or a link to an Internet Site, or similar method, that will play or replay the game session. The direct link or Internet Site is interfaced with the electronic casino game or the gaming system operating the games to provide the player or designee the ability to watch the game sessions or electronic game play at the scheduled time and/or at a later date and time. The site is for entertainment purposes only and does not allow players the ability place bets or wagers or modify any bets or wagers. In addition, the “Game play Link” or Internet Site also provides the player the ability to send links to the Game play or “Game play Clips” to the player's social media accounts to share their gaming experience with their social media friends.

At the end of a game session, the present disclosure provides the option to provide the player the ability to view statistics on the results of the game session. The statistics is derived from the gaming system and accumulates the statistics from the actual game play and summarizes the results or elements of the game session to review and analyze. It provides statistics such as, but not limited to, the total number of spins or plays, the total number of plays that result in a win, the total number of plays or spins that result in a loss, the total number of plays that results in wins over, $10, $25, $50, $75, $100 and so on, the longest number of consecutive spins that results in wins, the longest number of consecutive spins that result in a loss.

A scheduled game session provides casinos the ability to offer its patrons new and exciting methods to participate in the play of electronic casino games. In addition, the certain session games may be easily adjusted by the casino operator to revise up or down the effective payouts to the players through changing the fixed cost of a game session. Increasing the fixed cost of a game session will reduce the effective payout of a game session. Alternatively, by decreasing the fixed cost of a game session will increase the effective payout of a game session.

A player may play through various games based on the purchase of games sessions. The various games include Scheduled Game play, Predetermined number of Plays or spins, Predetermined time period, Side Bet, Game Session House Challenge, Game Session Player Challenge, Game Session Odds Game, Over/Under game session or Over/Under side bet, Odd/Even game session or Odd/Even Side Bet, and Multi-player game session. These games are explained in further detail below.

1. Scheduled Game play—While at a casino, players may want to play an electronic casino game, however the player may be distracted with other activities and/or unable to sit down and play an electronic gaming device. When a player has the ability to schedule a gaming session, he or she may play other casino games, eat at the restaurants, visit with friends, go the room, go the pool, go to the bar or lounge, go to a show or any other activities that players enjoy doing while at a casino or any other activities. Scheduling a gaming session allows players to do multiple activities at the same time. The player may watch the play of the game session at the scheduled date and time or at a later time and/or date. For example, a player may be playing poker and at the same time watch or monitor the scheduled game session. This results in providing the player additional flexibility with their schedule while in a casino and provides the player additional excitement while participating in an electronic casino game while playing other games or enjoying other activities. The player has the option of purchasing a game session that is based on a predetermined number of plays or spins, or a predetermined period of time.

2. Predetermined number of Plays or spins—A player may participate in a scheduled game play through entering the start time and the predetermined number of plays or spins of electronic casino games. When the player initiates a scheduled game play they enter the date and time to start the game play and the predetermined number of plays or spins to end the game session. For example, a scheduled game play may be scheduled to start at 8:00 PM on October XX, 20XX and end after 300 plays or spins.

3. Predetermined time period—A player may participate in a scheduled game play through entering the start time and the end time of electronic casino games. When the player initiates a scheduled game play they enter the date and time to start the game play and the date and time to stop the game play. For example, a scheduled game play may be scheduled to start at 8:00 PM on October XX, 20XX and end at 9:00 PM on October X, 20XX.

4. Side Bet—A player has an option to place a side bet on the results of the game session. For example, the player may place a $1 wager that at the end of the game session that the player will predict the ending credits of 335 for the game session. It is predetermined that if the player correctly predicts the ending credits, then the player wins 100 times the side bet or in this case $100. If the player ends up with 335 credits from the game session, then the player would win the 335 credits plus the $100 for correctly predicting the ending credit amount. This adds an additional level of excitement for the player to participate in an electronic casino game. Alternatively, the casino operator may offer any other types of side bets based on various elements or results of a game session.

5. Game Session House Challenge—A session game that a player initiates against the “House”. The player that initiates the game determines the game or game options, the number of plays or spins, and the date and time that the challenge begins. Both the player and the “House” participates in a game session with the same number of plays or spins. The player is able to challenge a single house account or multiple house accounts. If the player has the higher point total or credit level than the house game session or house game sessions, then the player wins the predetermined prize or award. if the house has the higher point or credit level, then the player does not win the prize or award. The game session house challenge may be scheduled for immediate play or at a date and time in the future. The advantage of this game is that a player may wager as little or as much as the player wants to wager. The player may play a 50 play or spin game session house challenge for a fixed wager for $20.00 or play a 300 play or spin game session house challenge for $20.00. In addition, the player may manage how aggressive the player wants to bet by adjusting the number of house accounts the player wants to play against. The player may play against a single house account with results in a 50%-50% chance of winning. Alternatively, the player may play against two house accounts and that results in a 33.34%-67.6% chance of winning, which would result in a higher winning if the player won the challenge. Alternatively, the player may play against three house accounts and that results in a 25%-75% chance of winning, which would result in a higher winning if the player won the challenge, and so on. This also provides the player with added excitement. Since this is a head to head game (against the house), the player has the excitement of watching the progress of his or her game session as well as watching the progress of the house game session or game sessions. The player is pulling for “wins” for each of the plays or spins on the player's game session and at the same time is pulling for loses for the house game sessions. The player is able to still win the game with a poor or low credit amount if the house account has a worse or a lower credit amount. This provides a different exciting method of participating in a slot machine or electronic casino game whereby a player winnings are based on the results of multiple electronic gaming devices.

6. Game Session Player Challenge—A game that a player initiates a game session against another player or players. Both the player and another player participates in a game session with the same number of plays or spins. The player is able to challenge a single player or multiple players. If the player has the higher point total or credit level than the other player or multiple players game sessions, then the player wins the prize or award. If the other player has the higher point or credit level, then the player does not win the prize or award. The game session player challenge may be scheduled for immediate play or at a date and time in the future. The advantage of this game is that a player may wager as little or as much as the player wants to wager. The player may play a 50 play or spin game session player challenge for a fixed wager for $20 or play a 300 play or spin game session player challenge for $20.00. In addition, the player may manage how aggressive the player wants to bet by adjusting the number of players that the player wants to play against. The player may play against a single player with results in a 50%-50% chance of winning. Alternatively, the player may play against two other players and that results in a 33.34%-67.6% chance of winning, which would result in a higher winning if the player won the challenge. Alternatively, the player may play against three other players and that results in a 25%-75% chance of winning, which would result in a higher winning if the player won the challenge, and so on. This also provides the player with added excitement. Since this is a head to head game (against other players), the player has the excitement of watching the progress of his or her game session as well as watching the progress of the other player or players game session(s). The player is pulling for “wins” for each of the plays or spins on the players' game session and at the same time is pulling for loses for the other player game sessions. The player is able to still win the game even if the player has a low total points or credits if the other player(s) has a worse total points or credits. This provides a different exciting method of participating in a slot machine or electronic casino game.

7. Game Session Odds Game—This is a method of a game that allows players to purchase a game session at predetermined length of time or a specific number of plays or spins. The player plays a slot machine or electronic casino game or similar game. rather than playing the game for the results of the game session, the player will a wager or wagers based on the odds of achieving certain elements or results during the play of the game session. The player may bet on certain elements of a game, examples are as follows, (1) achieving a 2, 3 or 5 spin or play win streak during the game session, or (2) achieving a 10, 15 or 20 spin or play losing streak during the game session, or (3) winning a Jackpot in excess of 200 credits, or (4) not achieving a play or spin that results in a win for at least 50 credits. The player may bet on certain results of the game, examples are as follows, (1) ending the game session with at least 100 credits, (2) ending the game session with at least 200 credits and so on, or (2) ending the game session with no credits, or (3) ending the game session between 100 and 200 credits, or (4) ending the game session between 200 and 300 credits, and so on, or ending up +/−10 credits of final credits, and so on, or (5) ending the game session with exactly 557 credits. These are some examples of bets that a player may wager on. For each of the elements and/or results that the player may bet will result in a predetermined payout multiple. Examples might be as follow, (1) Achieving a 3-game win streak during the game session—payout 3×amount bet, or (2) winning a 250 credit or more Jackpot during the game session—Payout 400×amount bet, or (3) ending up a game session with 0-100 credits—Payout 2×amount bet, or (4) predicting the exact # of credits on a game session—Payout 400×amount bet, or (5) predicting the # of credits +/−50 credits of a game session—Payout 5×amount bet. The player has control on how conservative or aggressive they are wanting to wager. For example:

a. A player may bet on the more difficult elements, such as a 3-spin winning streak or results, such as predicting the exact ending credits, which results in higher payout multiple.

b. Alternatively, a player may bet on easier elements, such as a 2-spin win streak or results, such as predicting the ending credits +/−100 credits, which results in lower payout multiple.

In addition, the player may control how much to wager. The player may wager $1 or $100 or more on each element and/or results of a game session.

In addition, the player may control if they want to play a short game such as a 25 spin or play game or a longer game such as a 300 spin or play a game for the same wager amount.

Accordingly, a player may wager $1 on a 300 spin or play game and bet on an easier to achieve elements or results. Under this scenario, the player may play for significant and of time on a device (300 spins or Plays) and not risking a significant amount. This will result in a low winnings amount.

Alternatively, a player may wager $100 on a 25 spin or play game and bet on more difficult to achieve elements or results. The player will play for short time on device and wagering a more significant amount. With this method of betting the player is risking a significant money and would win more if successful on the player's bets.

8. Over/Under game session or Over/Under side bet—Another method to participate in a game session is an Over/Under session game, whereby a player places wager if the ending credits from the play of the game session will be over or under a certain credit amount that is determined in advance. If the result of the game session results in the player winning the bet, then the player wins the predetermined payout.

9. Odd/Even game session or Odd/Even side bet—Another example of a side bet that a player may participate is odd/even side bet. The player has the ability to place a wager on a fixed spin or play game session if the ending credit amount from the game session would be an even number or an odd number. If the player correctly bets and chooses the correct result, odd or even, then the player wins the payout for that Side Bet.

10. Multi-player game session—Another method for a player to participate in a game session in a Multi-player game session. A multi-player game session is a system or method that a casino has a game session that continuously plays for a period of time. During this time period, a player or multiple players may independently participate in the same multi-player game session through purchasing a game session for a set number of plays or spins for a specified time period. Each player participates independently participates in the same game session through purchasing a game session. This allows multiple players to participate in the same electronic casino game.

Under the system or method of Scheduled game sessions of electronic casino games, a player may purchase a scheduled game session directly from a slot machine, Kiosk, from a computer or PDA type device or similar device located at a casino, or online where legal, or at any location that it is legal to play electronic casino games.

In order to participate in a game session, the following information is required for the player game account, or any similar method; (1) fund the wager or wagers for the play of a the game session, (2) identify the game or game session that is to be played, (3) identify the number of spins or Plays in the game session, if required (4) identify whether the game session starts immediately or the time and date that the game session starts, (5) identify the ending date and time, if necessary, (6) provide the Unique Link Identifier for the player, assignee or any other designated person such as email, text number, or other to allow the system to provide a link to watch or monitor the game session at the scheduled time or at a later date and time, if necessary (7) identify any individual or individuals that the player wants to assign any or all of the winnings of a game session, if necessary (8) any additional information or bets that may be required to play the game session, if necessary.

FIG. 8 is a block diagram of a system including computing device 800. Consistent with an embodiment of the disclosure, the aforementioned memory storage and processing unit may be implemented in a computing device, such as computing device 800 of FIG. 8. Any suitable combination of hardware, software, or firmware may be used to implement the memory storage and processing unit. For example, the memory storage and processing unit may be implemented with computing device 800 or any of other computing devices 818, in combination with computing device 800. The aforementioned system, device, and processors are examples and other systems, devices, and processors may comprise the aforementioned memory storage and processing unit, consistent with embodiments of the disclosure.

With reference to FIG. 8, a system consistent with an embodiment of the disclosure may include a computing device or cloud service, such as computing device 800. In a basic configuration, computing device 800 may include at least one processing unit 802 and a system memory 804. Depending on the configuration and type of computing device, system memory 804 may comprise, but is not limited to, volatile (e.g. random access memory (RAM)), non-volatile (e.g. read-only memory (ROM)), flash memory, or any combination. System memory 804 may include operating system 805, one or more programming modules 806, and may include a program data 807. Operating system 805, for example, may be suitable for controlling computing device 800's operation. In one embodiment, programming modules 806 may include image encoding module, machine learning module and image classifying module. Furthermore, embodiments of the disclosure may be practiced in conjunction with a graphics library, other operating systems, or any other application program and is not limited to any particular application or system. This basic configuration is illustrated in FIG. 8 by those components within a dashed line 808.

Computing device 800 may have additional features or functionality. For example, computing device 800 may also include additional data storage devices (removable and/or non-removable) such as, for example, magnetic disks, optical disks, or tape. Such additional storage is illustrated in FIG. 8 by a removable storage 809 and a non-removable storage 810. Computer storage media may include volatile and nonvolatile, removable and non-removable media implemented in any method or technology for storage of information, such as computer-readable instructions, data structures, program modules, or other data. System memory 804, removable storage 809, and non-removable storage 810 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 800. Any such computer storage media may be part of device 800. Computing device 800 may also have input device(s) 812 such as a keyboard, a mouse, a pen, a sound input device, a touch input device, etc. Output device(s) 814 such as a display, speakers, a printer, etc. may also be included. The aforementioned devices are examples and others may be used.

Computing device 800 may also contain a communication connection 816 that may allow device 800 to communicate with other computing devices 818, such as over a network in a distributed computing environment, for example, an intranet or the Internet. Communication connection 816 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 804, including operating system 805. While executing on processing unit 802, programming modules 806 (e.g., application 820) may perform processes including, for example, one or more stages of methods 500, 600 and 700 as described above. The aforementioned process is an example, and processing unit 802 may perform other processes.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, multiprocessor systems, microprocessor-based or programmable consumer electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

Although the invention has been explained in relation to its preferred embodiment, it is to be understood that many other possible modifications and variations can be made without departing from the spirit and scope of the invention.

I/We claim:

1. A method of operating a gaming machine, the method comprising:
receiving, using a processing device, a gaming request from a user, wherein the gaming request is associated with a gaming session comprising a plurality of plays, wherein the gaming request comprises indication of:
at least one of a count of the plurality of plays and a time period of the gaming session;
at least one wagering amount associated with the gaming session;
at least one time-schedule associated with the gaming session, wherein one or more plays of the plurality of plays are initiated according to the at least one time-schedule;
receiving, using a processing device, an assignment request comprising indication of at least one assignee;
executing, using the processing device, the gaming session;
determining, using the processing device, at least one winning result associated with the gaming session; and
assigning, using the processing device, at least a portion of the winning amount to the at least one assignee.

2. The method of claim 1 further comprising deducting, using the processing device, gaming credits from an account of the user associated with the request, wherein the gaming credits are based on at least one of the count and the time period.

3. The method of claim 1 further comprising receiving, using the processing device, at least one side bet associated with the gaming session, wherein the at least one side bet comprises each of a predicted result of the gaming session and a side bet amount.

4. The method of claim 3, wherein the predicted result comprises a quantity of gaming credits remaining upon completion of the gaming session.

5. The method of claim 3, wherein the predicted result comprises a numerical characteristic of gaming credits remaining upon completion of the gaming session.

6. The method of claim 1, wherein the at least one time-schedule comprises a play interval, wherein a time gap between initiation of two consecutive plays is based on the play interval.

7. The method of claim 1, wherein the gaming request further comprises indication of:
automatically repeating the gaming session;
at least one condition based on which the gaming session is automatically repeated; and
a time of repeating the gaming session.

8. The method of claim 1, wherein the assignment request further comprises indication of at least one percentage associated with the at least one assignee, wherein assigning of the winning amount to the at least one assignee is further based on the at least one percentage.

9. The method of claim further comprising performing at least one of:
crediting, using the processing device, at least one assignee account associated with the at least one assignee with the portion of the winning amount; and
transmitting, using a communication device, a message to at least one user device associated with the at least one assignee.

10. The method of claim 1 further comprising performing:
receiving, using an input device, identifying data associated with at least one of the user and the at least one assignee;
identifying, using the processing device, at least one of the user and the at least one assignee based on the identifying data; and
dispensing, using the processing device, at least one item based on the identifying, wherein at least one of a type and a quantity of the at least one item is based on the winning amount.

11. The method of claim 1 further comprising:
monitoring, using the processing device, a state of the gaming machine associated with the gaming session; and
transmitting, using a communication device, the state of the gaming machine to at least one user device associated with at least one of the user and the at least one assignee.

12. A system of operating a gaming machine, the system comprising a processing device configured for:
receiving a gaming request from a user, wherein the gaming request is associated with a gaming session comprising a plurality of plays, wherein the gaming request comprises indication of:
at least one of a count of the plurality of plays and a time period of the gaming session;
at least one wagering amount associated with the gaming session;
at least one time-schedule associated with the gaming session, wherein one or more plays of the plurality of plays are initiated according to the at least one time-schedule;
receiving an assignment request comprising indication of at least one assignee;
executing the gaming session;
determining at least one winning result associated with the gaming session; and
assigning at least a portion of the winning amount to the at least one assignee.

13. The system of claim 12, wherein the processing device is further configured for deducting gaming credits from an account of the user associated with the request, wherein the gaming credits are based on at least one of the count and the time period.

14. The system of claim 12, wherein the processing device is further configured for receiving at least one side bet associated with the gaming session, wherein the at least one side bet comprises each of a predicted result of the gaming session and a side bet amount.

15. The system of claim 14, wherein the predicted result comprises a quantity of gaming credits remaining upon completion of the gaming session.

16. The system of claim 14, wherein the predicted result comprises a numerical characteristic of gaming credits remaining upon completion of the gaming session.

17. The system of claim 12, wherein the at least one time-schedule comprises a play interval, wherein a time gap between initiation of two consecutive plays is based on the play interval.

18. The system of claim 12, wherein the gaming request further comprises indication of:
automatically repeating the gaming session;
at least one condition based on which the gaming session is automatically repeated; and
a time of repeating the gaming session.

19. The system of claim 12, wherein the assignment request further comprises indication of at least one percentage associated with the at least one assignee, wherein assigning of the winning amount to the at least one assignee is further based on the at least one percentage.

20. The system of claim 12, wherein the processing device is further configured for performing at least one of:
crediting at least one assignee account associated with the at least one assignee with the portion of the winning amount; and
transmitting, using a communication device, a message to at least one user device associated with the at least one assignee.

21. The system of claim 12, wherein the processing device is further configured for performing:
receiving, using an input device, identifying data associated with at least one of the user and the at least one assignee;
identifying at least one of the user and the at least one assignee based on the identifying data; and
dispensing at least one item based on the identifying, wherein at least one of a type and a quantity of the at least one item is based on the winning amount.

22. The system of claim 12, wherein the processing device is further configured for:
monitoring a state of the gaming machine associated with the gaming session; and
transmitting, using a communication device, the state of the gaming machine to at least one user device associated with at least one of the user and the at least one assignee.
